(19) United States
(12) Patent Application Publication
(10) Pub. No.: US 2003/0209086 A1
(43) Pub. Date: Nov. 13, 2003

(54) Force-measuring element for a scale, and scale

(75) Inventors: Michael Schurr, Murrhardt (DE); Klaus Leber, Hahnstatten (DE)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Soehnle-Waagen GmbH & Co.KG, Murrhardt (DE)

(21) Appl. No.: 10/387,943

(22) Filed: Mar. 13, 2003

(30) Foreign Application Priority Data
Mar. 15, 2002 (DE) DE 102 11 421.8
Jun. 14, 2002 (DE) DE 102 26 770.7
Oct. 9, 2002 (DE) DE 102 47 076.6

(51) Int. Cl. G01G 3/14; G01L 1/22; G01L 5/00

(52) U.S. Cl. 73/862.68; 73/862.541; 177/244

(57) ABSTRACT

A force-measuring element for a scale is provided which includes a first end region via which the force-measuring element is adapted to be supported, a second end region which is adapted to have a load to be measured applied thereto, and a central region provided between the first and second end regions to form a measuring point. A cross-sectional weakening is formed in the central region. The central region has a greater height than at least one of the first and second end regions. And a top side and an underside of the force-measuring element approach one another in both a first transition region and a second transition region which respectively begin at the central region and extend toward the first and second end regions, respectively.

### FIELD OF THE INVENTION

This invention relates to a beamlike force-measuring element for a scale, which is adapted to be supported at a first end region and which is adapted to be subjected to a load to be measured at second end region, wherein a cross-sectional weakening formed by a transversely extending recess is provided in a central region disposed approximately centrally between the first and second end regions to form a measurement point. This invention also relates to a scale having such a force-measuring element.

### BACKGROUND OF THE INVENTION

A force-measuring element for a scale, which is also known as a weighing cell or a force pickup, is widely known. Conventionally, the force-measuring element is fastened between a substrate on one side and a load plate on the other. When a force is exerted on the load plate, strains arise in the force-measuring element that are detected by strain gauges. The conventional force-measuring element is connected to both the substrate and the load plate by means of screws. In order to form a solid connection, high prestressing forces of the screws are required. This results in strains in the material of the force-measuring element, which are detected as interference signals by the strain gauges. As a result, the precision of measurement of the conventional force-measuring element may be considerably impaired, because a change in the load state causes a change in the prestressing forces of the screws, with an immediate change in the strains on the force-measuring element.

To obtain a force-measuring element with high measurement precision, it is therefore necessary to reduce the influence of the manner in which fastening is achieved. On the one hand, the effect of the fastening can be reduced by lengthening the force-measuring element, so that material strains on the force-measuring element can be diminished by a feasible increase in the spacing between the fastening points to the substrate on the one hand and the load plate on the other. In such an embodiment, however, the disadvantages are increased material consumption, an enlargement of the installation space, and an increase in the bending stresses on the force-measuring element.

It is also conceivable to provide relief notches in the force-measuring element between the region where the strain gauges are located and the fastening points to the substrate and the load plate. However, it is then disadvantageous that material consumption is again high. In addition, such a force-measuring element is expensive to produce, since additional metal-cutting machining operations must be performed for forming the relief notches.

It is also conceivable to form the force-measuring element with greater material thickness at the fastening points to the substrate and the load plate than in the region where the strain gauges are disposed. In this way, the fastening regions of the force-measuring element can be reinforced, and stresses caused by the fastening can be reduced. However, in such an embodiment there is again the disadvantage of increased material consumption, and there is also a considerable increase in weight of the force-measuring element.

### OBJECT OF THE INVENTION

The first object of the present invention is to provide a beamlike force-measuring element which has high measurement precision and at the same time which can be produced from only a small amount of material at an economic cost. In addition, it is a second object of the present invention to provide a scale that measures precisely and that is economical to produce.

### SUMMARY OF THE INVENTION

The first object of the present invention is attained by providing a force-measuring element which comprises a first end region via which the force-measuring element is adapted to be supported, a second end region which is adapted to have a load to be measured applied thereto, and a central region provided between the first and second end regions to form a measuring point, wherein cross-sectional weakening is formed in the central region, wherein the central region has a greater height than at least one of the first and second end regions, and wherein a top side and an underside of the force-measuring element approach one another in both a first transition region and a second transition region which respectively begin at the central region and extend toward the first and second end regions, respectively.

The second object of the present invention is attained by providing a scale which comprises the above described force-measuring element connected to a substrate at the first end region and connected to a load plate at the second end region.

### BRIEF DESCRIPTION OF THE DRAWINGS

FIG. 1 is a side view of one embodiment of the force-measuring element of the present invention;

FIG. 2 is a plan view of the force-measuring element shown in FIG. 1;

FIG. 3 illustrates a scale having the force-measuring element shown in FIG. 1 incorporated therein; and

FIG. 4 illustrates a scale having another force-measuring element incorporated therein.

### DETAILED DESCRIPTION

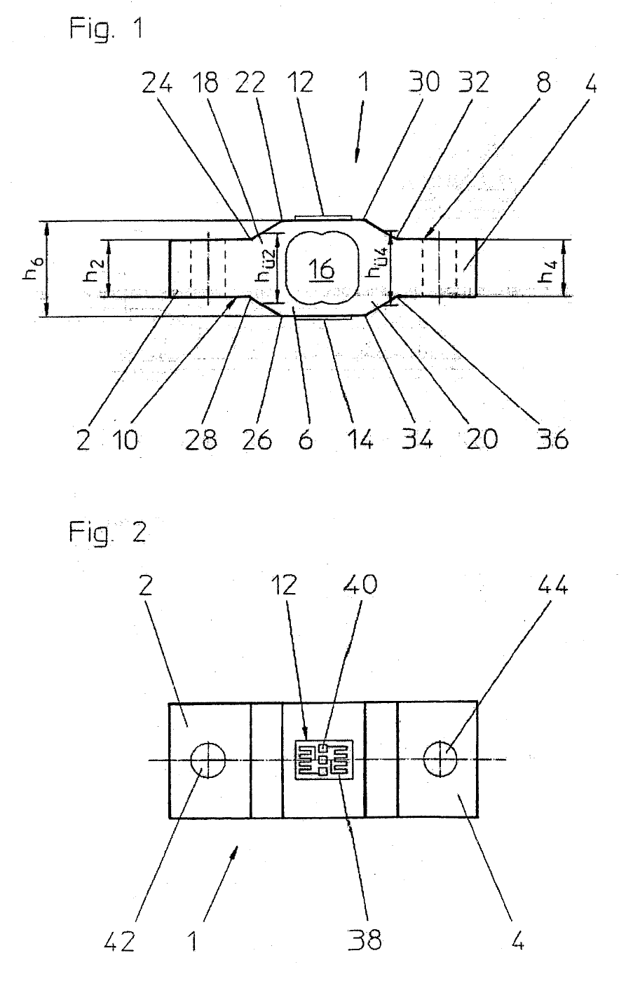

FIG. 1 shows a side view of a beamlike force-measuring element 1 having a first end region 2 via which the force-measuring element 1 is adapted to be supported, and a second end region 4 which is adapted to have a load to be measured applied thereto. A central region 6 of the force-measuring element 1 forms a measuring point, and respective measuring elements 12, 14 which act as strain gauges are provided on both the top side 8 and the underside 10 of the force-measuring element 1. The strain gauges may, for example, be glued to the central region 6. The central region 6 also has a recess 16, extending transversely in the beam like force measuring element 1, to form a cross-sectional weakening. The cross-sectional weakening need not be formed by a recess as shown, but instead can also be formed by a weakening of some other kind, such as a blind bore.

It can also be seen from FIG. 1 that the central region 6 has a greater height h6 than the end regions 2, 4, which have lesser heights h2, h4. Between the central region 6 and the first end region 2, there is a first transition region 18, and a second transition region 20 is disposed between the central region 6 and the second end region 4. In the transition regions 18, 20, from the central region 6 in the direction of the respective end regions 2, 4, both the top side 8 and the underside 10 of the force-measuring element approach one another. As a result, the height h2 of the first transition region 18 decreases in the direction of the first end region 2. The same is true for the height h4 for the second transition region 20 in the direction of the second end region 4. In this exemplary embodiment, the respective heights hu2, hu4 of the transition regions 18, 20 vary continuously and linearly from the central region in the direction of the end regions 2, 4. The first transition region 18 is defined on the top side 8 of the force-measuring element 1 by edges 22, 24 and on the underside 10 by edges 26, 28. The same is true for edges 30, 32 on the top side 8 and edges 34, 36 of the underside 10 of the force-measuring element 1, which define the second transition region 20. However, the transition regions 18, 20 can also merge continuously, that is, without edges, with the central region 6 and the end regions 2, 4.

With the structure shown in FIG. 1, the central region 6 has a greater height than at least one of the first and second end regions 2 and 4, and the top side 8 and under side 10 of the force-measuring element 1 approach each other in the transition regions 18 and 20 beginning at the central region 6 and extending toward the first and second end regions 2 and 4, respectively.

Thus, the central region 6 has a greater height than the first end region 2 that supports the force-measuring element and/or the second end region 4 through which the force to be measured is introduced into the force-measuring element 1. And as a result, the high material strains that would otherwise occur in the first and/or second end regions 2 and 4 are broken at the first and second transition regions 18 and 20 from the ends to the measuring point that has a greater height. The effects of the stresses occurring at the end regions on the measuring point are considerably reduced and no longer cause significant measurement errors. The force-measuring element 1 thus has an especially high measurement precision and can nevertheless be formed in a compact manner with an especially light weight. Moreover, complicated and expensive machining during the production of the force-measuring element 1 is no longer necessary.

One could imagine that the transition from the end region to the central region could be embodied abruptly as a vertical shoulder. It is an advantageous feature of the present invention, however, that the height of the transition regions 18 and 20 from the central region 6 in the direction of the respective end regions 2 and 4 decreases continuously, making for still greater economy in terms of the material required for forming the force-measuring element 1.

A plan view on the force-measuring element 1 of FIG. 1 is shown in FIG. 2. Here and in the other drawings, the same reference numerals identify corresponding elements. As shown in FIG. 2, the measuring element 12 mounted on the top side comprises a strain gauge 38. Terminal contacts 40 of the measuring element 12 serve to provide electrical connection to an electronic evaluation unit (not shown). Both the first end region 2 and the second end region 4 have respective connection portions 42, 44 for receiving fastening elements, such as screws.

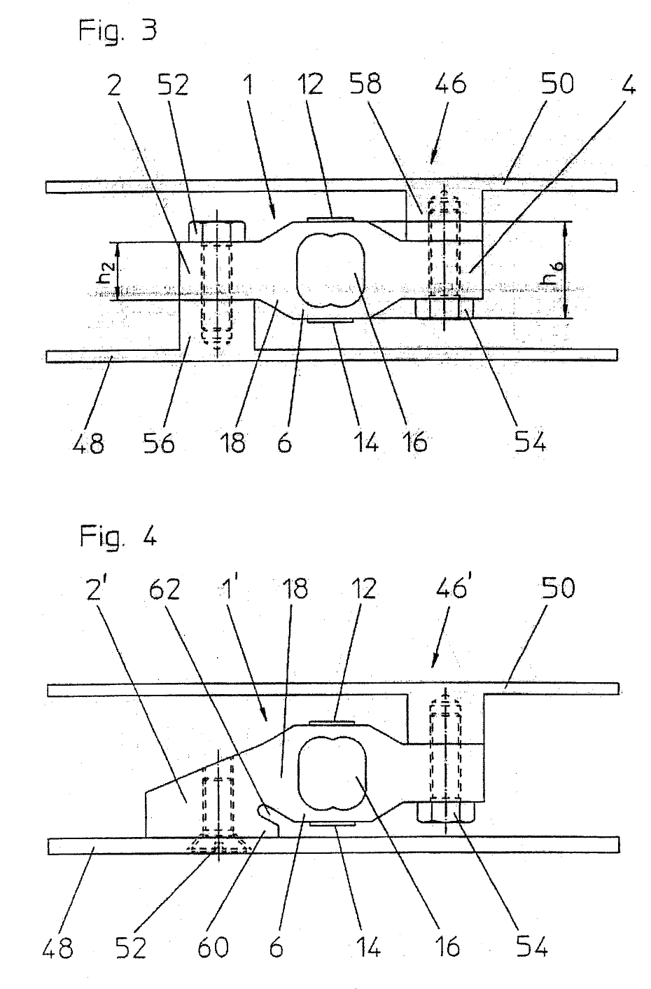

FIG. 3 shows the force-measuring element 1 of FIGS. 1 and 2 in an installed state in a scale 46. The scale 46 has 2a substrate 48, embodied as a base plate, and a load plate 50. The substrate 48 is connected to the first end region 2 of the force-measuring element 1, and the load plate 50 is joined to the second end region 4. The connections are each embodied as screw connections, with screws 52, 54. The screws 52, 54 reach through connection portions 42, 44 provided in the first and second end regions 2, 4 of the force-measuring element 1 and are screwed into first and second receptacles 56, 58, respectively. The first receptacle 56 is solidly joined to the substrate 48, and the second receptacle 58 is solidly joined to the load plate 50.

A scale of the type shown in FIG. 3, for example, has especially high measurement precision on the one hand, and on the other comprises only a few components. As a result, high precision is attained along with the possibility of simple, economical production.

A scale 46′ according to another embodiment of the present invention is shown in a side view in FIG. 4. The scale 46′ comprises a force-measuring element 1′ which differs from the force-measuring element 1 of FIGS. 1-3 in that a first end region 2′ of the force-measuring element 1′ comprises a base 60 for connection to a substrate 48 embodied as a base plate. Between the base 60 and the first transition region 18 (which is disposed between the central region 6 and the first end region 2′), a relief notch 62 is provided. The base 60 of the force-measuring element 1′ is screwed directly to the substrate 48 by means of a screw 52. Thus a receptacle 56 of the kind utilized in the exemplary embodiment shown FIG. 3 can be dispensed with.

The first and second end regions 2 and 4 of the force-measuring element 1 according to the first embodiment of the present invention can for instance be embodied in a simple way as connection tabs.

Conversely, for variable possible uses of the force-measuring element and to reduce the number of components, it can be advantageous if the first and/or second end region 2′ or 4′ is embodied as the base 60 for connection to the substrate 48 or the load plate 50, as according to the above described embodiment of the present invention shown in FIG. 4, for example. The substrate 48, on which the force-measuring element 1′ can be supported, or the load plate 50, on which the load to be measured is to be disposed, can then be connected directly to the base 60. To further increase the measurement precision, the relief notch 62 is disposed between the first transition region 18 and the base 60.

In order to enable the central region 6 to form a measuring point, arbitrary embodiments are fundamentally conceivable. For example, the central region 6 may comprise at least one measuring element 12 for stresses and/or strains, and as a result in a simple way, the stresses and/or strains that occur at the surface of the beamlike force-measuring element due to the load to be measured can be detected as a measure for the weight of the load. High measurement precision and at the same time the possibility of large-scale mass production of the force-measuring element at low cost are advantageously attained if, for example, the measuring element 12 is embodied as a strain gauge 38.

The force-measuring element of the present invention can be built into a scale detachably by means of positive-engagement connections, or it can be joined non-detachably to a substrate and/or to a load plate, for example. However, this requires major effort and expense and high precision in constructing the scale. For variable use of the force-measuring element of the invention and to make it easy to install and replace, it is especially advantageous that in a further feature of the invention, the first and second end regions have the recesses 42, 44 for receiving fastening elements. These fastening elements can preferably be screws 52, 54, making an economical, detachable connection of the force-measuring element to the substrate and the load plate possible.

The force-measuring element of the present invention, moreover, can be produced with high precision and at very low cost if it essentially comprises an extruded metal profile; “essentially” here means that only individual elements such as strain gauges or bores must additionally be made in the metal profile.

Preferably, the body of the force-measuring element is made from an aluminum alloy, and in particular from an aluminum wrought alloy.

Additional advantages and modifications will readily occur to those skilled in the art. Therefore, the invention in its broader aspects is not limited to the specific details, representative devices, and illustrated examples shown and described herein. Accordingly, various modifications may be made without departing from the spirit or scope of the general inventive concept as defined by the appended claims and their equivalents.

We claim:

1. A force-measuring element for a scale, said force-measuring element comprising:
a first end region via which the force-measuring element is adapted to be supported;
a second end region which is adapted to have a load to be measured applied thereto;
a central region provided between the first and second end regions to form a measuring point; and
a cross-sectional weakening formed in the central region;
wherein the central region has a greater height than at least one of the first and second end regions; and
wherein a top side and an underside of the force-measuring element approach one another in both a first transition region and a second transition region which respectively begin at the central region and extend toward the first and second end regions, respectively.

2. The force-measuring element of claim 1, wherein the cross-sectional weakening is formed by a recess extending transversely across the central region.

3. The force-measuring element of claim 1, wherein the first end region comprises a first connection portion for connection to a substrate, and the second end region comprises a second connection portion for connection to a load plate.

4. The force-measuring element of claim 1, wherein a height of each of the first and second transition regions decreases continually from the central region toward each of the first and second end regions, respectively.

5. The force-measuring element of claim 1, wherein at least one measuring element is provided in the central region for measuring stresses and/or strains.

6. The force-measuring element of claim 5, wherein the at least one measuring element comprises a strain gauge.

7. The force-measuring element of claim 1, wherein the first and second end regions each comprise a recess for receiving a fastening element.

8. The force-measuring element of claim 1, wherein the force-measuring element comprises an extruded metal profile.

9. The force-measuring element of claim 1, wherein the first end region comprises a base for connection to a substrate.

10. The force-measuring element of claim 9, wherein a relief notch is disposed between the first transition region and the base.

11. A scale comprising:
a force-measuring element including a first end region via which the force-measuring element is adapted to be supported, a second end region which is adapted to have a load to be measured applied thereto, and a central region provided between the first and second end regions to form a measuring point;
a substrate connected to the first end region of the force-measuring element; and
a load plate connected to the second end region of the force-measuring element;
wherein a cross-sectional weakening formed in the central region of the force-measuring element;
wherein the central region of the force-measuring element has a greater height than at least one of the first and second end regions; and
wherein a top side and an underside of the force-measuring element approach one another in both a first transition region and a second transition region which respectively begin at the central region and extend toward the first and second end regions, respectively.

12. The scale of claim 11, wherein the first and second end regions of the force-measuring element are connected to the substrate and the load plate, respectively, by screws.
